(19) United States
(12) Patent Application Publication
(10) Pub. No.: US 2002/0078799 A1
(43) Pub. Date: Jun. 27, 2002

(54) Two-stop wrench

(76) Inventor: David F. Friedman, McHenry, IL (US)

Correspondence Address: JON C GEALOW & ASSOCIATES, 2903 NORTH BAYVIEW LANE, MCHENRY, IL, 60050

(21) Appl. No.: 10/007,717

(22) Filed: Nov. 13, 2001

Related U.S. Application Data
(60) Provisional application No. 60/246,894, filed on Nov. 10, 2000.

(51) Int. Cl. B25B 13/00

(52) U.S. Cl. 81/125.1

(57) ABSTRACT

The present invention is an apparatus, including wrenches, to facilitate the installation and replacement of mechanical devices, particularly plumbing compression fittings such as angle-stop valves. The apparatus has a first member that includes an open-end wrench with three-jaw surfaces and a hollow handle extending therefrom. A second member also includes an open-box wrench and a handle extending therefrom, the handle of the second member being of a diameter small enough to slidably fit within the handle of the first member. The handles of the first and second members preferably including mating fasteners so as to enable the temporary locking of the two members for use and or storage of the two-pieces of the apparatus. The handle of the second member further includes at least two positioning members extending therefrom, one being retractable, and having certain sizes so as to allow the positioning member end of the wrench to engage the inner diameter of angle-stop valve of different sizes during installation.

This invention relates generally to an apparatus employed in the plumbing trades, and more particularly to a two-piece tool that is employed in the installation of at least two sizes of compression valves or stops and their associated compression couplings, whereby the installer needs only the single tool.

### CROSS-REFERENCE TO RELATED APPLICATIONS

The following U.S. Patent application is hereby incorporated by reference in its entirety for its teachings:

U.S. application Ser. No. 09/523,031 for COMPRESSION STOP AND COUPLING WRENCH by David F. Friedman et al, filed Mar. 10, 2000.

### BACKGROUND AND SUMMARY OF THE INVENTION

There exists in the plumbing industry a widely used fitting known as a compression stop or a compression stop valve, or more particularly as ⅝″×⅜″ and ⅝″×½″ compression straight or angle-stop valves. For many years, such fittings were attached to plumbing systems by soldering the fitting or via an internally threaded opening being screwed onto threaded male nipples that were part of the domestic water plumbing systems. Angle-stops were eventually introduced with compression-type fittings so as to eliminate the need to solder or screw the threaded male nipples at the water outlets. The compression type stop is now the predominant means for terminating plumbing water supplies at locations near plumbing fixtures such as faucets, toilets, etc. The compression stops provide an easy method to control the water supply, without shutting down the entire system, in the event that the associated fixture needs repair or replacement.

Typically, angle-stops and similar compression fittings are installed using one of two different sets of tools. The most common method is for a plumber or do-ityourselfer to use two or three adjustable wrenches (e.g., Crescent™ wrenches). However, this method tends to be cumbersome and time consuming because there is a constant need to re-adjust the wrenches to fit the different dimensioned surfaces of the compression stop and the compression nuts associated with the compression stops. Similarly, the adjustable wrenches are often of a size that prohibits their use in cramped surroundings such as within a sink or lavatory vanity cabinet. A second method, often used by those with more experience in the installation of compression stops, employs automotive-style open-end wrenches that are of fixed sizes necessary to accommodate all the surfaces of a compression stop and the compression nuts. Unfortunately, the latter approach often requires as many as four different wrenches. These wrenches, like the adjustable wrenches, are made for heavy-duty use. That is, where a user needs to apply significant torque to a nut or bolt (e.g., automotive applications). Thus, they too are generally longer and more heavily constructed than is necessary for the installation of compression stops. Lastly, the automotive-style open-end wrenches, and the adjustable wrenches, are often constructed with an angled offset between the wrench head and the handle, which may complicate the alignment of a compression stop with the tubing riser to the faucet to which it is to be connected.

Experience suggests that the methods using both sets of tools are tedious and time consuming, particularly in confined areas. Furthermore it is often too dark or otherwise difficult to obtain an accurate view of the final fixed angle of the compression stop and its angular relationship with the supply tubing from the associated faucet. A compression joint requires precise alignment. When compression connections are significantly mis-aligned, they require disassembly and readjustment, to obtain a water tight connection. Due to the built-in angle of the automotive, or adjustable wrenches, the installer experiences a constant need to “roll” or rotate the wrench 180 degrees around its axis, in order to approach the compression nut at different angles, to facilitate movement of the wrench handle far enough to avoid obstacles while exerting the necessary wrenching force on the compression nut.

In order to alleviate the afore-described difficulties with the installation of compression type angle-stop devices, and their associated faucet supply tubes, the present invention is a two-piece apparatus that enables the user to completely install a compression stop plumbing fitting, or similar mechanical device, without the need for additional tools. Moreover, various features of the present invention facilitate the installation of such fittings in areas that are difficult to access.

Heretofore, a number of patents have disclosed wrenches associated with angle-stops, the relevant portions of which may be briefly summarized as follows:

U.S. Pat. No. 4,016,783 to Spector at al., issued Apr. 12, 1977, discloses a wrench designed for screwing a polished angle valve or similar plumbing fitting without leaving unsightly teeth marks on it. The wrench is particularly suited for the installation of threaded angle-stops as were commonly used in the 1970's.

U.S. Pat. No. 4,542,666 to White, issued Sep. 24, 1985, teaches a wrench for freeing or turning oval handles such as those often found on angle-stop valves and fittings.

In accordance with the present invention, there is provided a two-part wrench, comprising a first member, including a first wrenching head and an elongated partially hollow handle extending therefrom. The first wrenching head is suitable for holding a mechanical device of one of three diameters or distance between parallel faces. The second member including a second wrenching head and elongated handle extending therefrom. The second wrenching head is suitable for holding a mechanical device having a plurality of generally flat sides intersecting at a plurality of corners, with pairs of said sides being parallel to each other. The elongated handle of the second member is formed for insertion along a longitudinal direction, within the hollow portion of the handle of the first member. The first and second members each include complimentary mating fasteners to provide for the temporary connection of the first and second members when the elongated handle of the second member is inserted within the hollow portion of the handle of the first member.

In accordance with another aspect of the present invention, there is provided a two-part wrench, comprising: a first member including a three-jawed open-end wrenching head and an elongated partially hollow handle extending therefrom; and a second member including a split-box wrenching head and an elongated handle extending therefrom. The elongated handle of the second member is suitable for slidable insertion, along a longitudinal direction, within the hollow portion of the handle of the first member. The first and second members each include complimentary mating fasteners so as to allow the temporary connection of the first and second members when the elongated handle of the second member is inserted within the hollow portion of the handle of the first member.

In accordance with yet a further aspect of the present invention, there is provided a wrench, comprising: a wrenching head suitable for holding a mechanical device having a plurality of generally flat, parallel sides; an elongated handle attached to and extending from said wrenching head; and a retractable lug or positioning member. The retractable lug or positioning member extends longitudinally from the end of the elongated handle opposite the wrenching head. The retractable lug or positioning member is of a predetermined cross-section and of a first outer diameter suitable for engaging an inner surface of a mechanical device having the same predetermined cross-section. The elongated handle being of a second predetermined cross-section, larger than the first predetermined cross-section suitable for engaging an inner surface of a mechanical device having the same second predetermined cross-section.

One aspect of the invention deals with a basic problem in the plumbing industry, that is, the installation of angle-stop and similar compression fittings in an enclosed, limited-access space. This aspect is further based on the discovery of a technique that alleviates this problem. The technique utilizes a two-piece tool that incorporates features not found in other tools used for the same purposes. For example, the two-piece tool is separable into its two component members when being used, but may be reassembled for storage prior to further use on other fittings or mechanical devices. When separated, the tool not only provides various “wrenching” surfaces for turning and/or holding components of an angle-stop fitting, but also provides features that facilitate the accurate positioning and alignment of the fitting with its associated fixture. Furthermore, the present invention employs a design whereby a single wrench may be employed to work on both of the typical compression stop sizes typically used, that is: (⅝″×⅜″ and ⅝″×½″).

One aspect of the invention is based on the observation of problems with conventional wrenches and techniques using them for the installation of such fittings. Often the tools used will result in the marring of the outer surface of the fitting, or will require that significant time be expended adjusting a wrench, searching for the desired size wrench, or requiring re-adjusting the orientation or position of the fitting after it is first installed. The present invention overcomes the positioning problem by incorporating at least two lug-like or positioning members on the end of one of the members. One of which positioning members is retractable, so as to allow for holding and accurately positioning of fittings of two different sizes during installation, rather than requiring readjustment after the fitting is installed.

The technique and apparatus described herein is advantageous because the apparatus is a single multi-part tool that provides the functionality of multiple conventional tools required for the installation of two sizes of angle-stops and similar compression fittings. It also makes it unnecessary to have multiple wrenches for the installation of the various compression fittings. As a result of the invention, plumbers and do-it-yourselfers will be able to easily install compression-type fittings in a reduced amount of time without marring the fitting, and will avoid the necessity of storing and carrying multiple tools.

### BRIEF DESCRIPTION OF THE DRAWINGS

FIG. 1 is a top elevation view of a first portion of a two piece tool in accordance with this invention:

FIG. 2 is a cross-sectional view taken along the line 2-2 in FIG. 1:

FIG. 3 is a left end view of the first portion of the two piece tool shown in FIG. 1:

FIG. 4 is a side elevation view of the first portion of the two piece tool shown in FIG. 1:

FIG. 5 is a right end view of the first portion of the two piece tool shown in FIG. 1:

FIG. 6 is an enlarged view of the wrenching head of the first portion of the two piece tool shown in FIG. 1:

FIG. 7 is a top elevation view of a second portion of a two piece tool in accordance with this invention:

FIG. 8 is a left end view of the second portion of the two piece tool shown in FIG. 7:

FIG. 9 is a side elevation view of the second portion of the two piece tool shown in FIG. 7:

FIG. 10 is a right end view of the second portion of the two piece tool shown in FIG. 7, and

FIG. 11 is an enlarged view of the wrenching head of the second portion of the two piece tool shown in FIG. 7.

### DESCRIPTION OF THE PREFERRED EMBODIMENT

For a general understanding of the present invention, reference is made to the drawings. In the drawings, like reference numerals have been used throughout to designate identical elements. In describing the present invention, the following term(s) will be used in the description.

The terms “compression stop,” “compression valve” and “angle-stop” are generally used herein to characterize a plumbing fitting that connects to a water supply system to provide a shut-off for an associated plumbing fixture. Each of the fittings has at least one compression component wherein a ferrule and compression nut are employed to assure a watertight connection between the fitting and tubing or pipe to which it is connected. Such fillings also have a valve handle or other mechanism by which a user can stop the supply of liquid to the riser tube.

The term “lug” or “positioning member” is been employed herein to represent an element or aspect of the tool that protrudes therefrom and is of a size and shape so as to fit within a riser or other opening of a plumbing fitting for which it is designed. The lug or positioning member may be set off from the remainder of the tool by a shoulder or similar feature, and the shoulder may serve to limit the distance that the lug or positioning member may be inserted into a receiving member. However, use of the term lug or positioning member in the following description and appended claims is intended to include elements or aspects of the tool that protrude therefrom and fit into an opening of the fitting, whether or not it is set off by a shoulder.

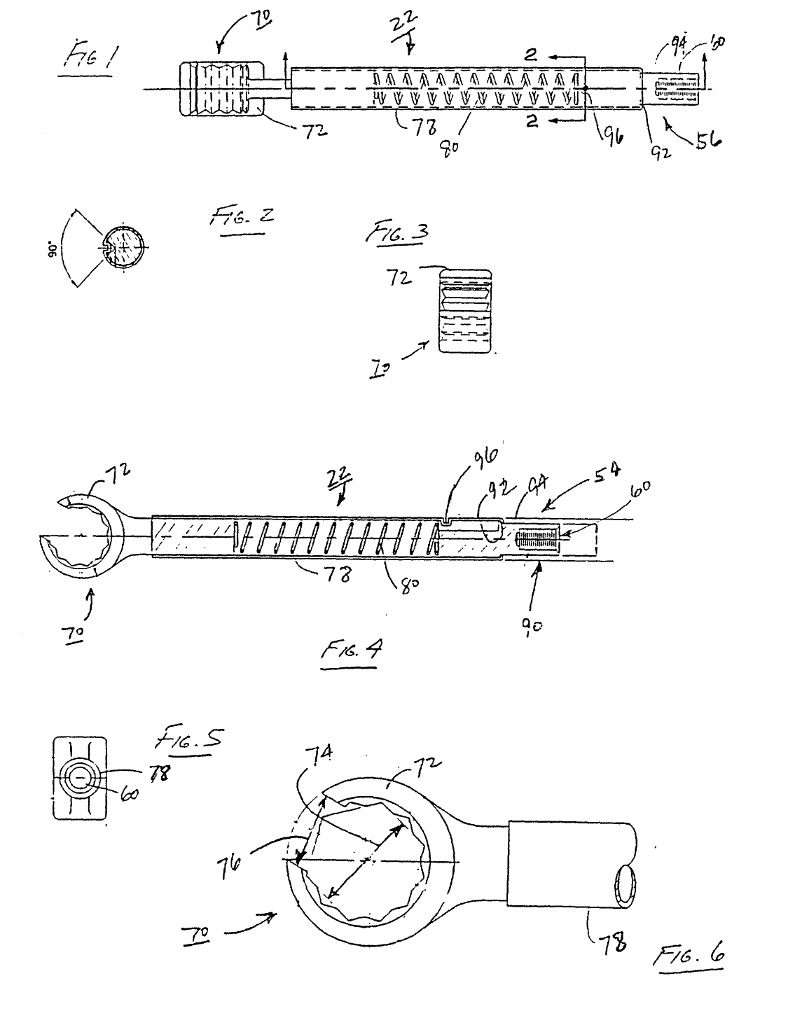

Referring now to FIGS. 1, 4, 7 and 9, there are depicted disassembled views of the two-piece, two stop wrench. The wrench includes a first member 20 and a second member 22, both of which are preferably formed from a rigid metal alloy (cast, forged, rolled, extruded, etc.), a sintered powdered material, high-strength plastic or similar material with properties making it suitable for use as a tool. First member 20 includes a wrenching head 26 and an elongated hollow handle 28. The wrenching head 26 includes at least three pairs of jaws 32a, 32b and 32c as shown in FIG. 11, and a throat 36 interconnecting the jaws. The throat 36 preferably has a curved outer surface that not only connects the two jaws, but also provides for a transition to the elongated handle 28 in the embodiment shown. Each of the jaws (32a, 32b and 32c) has at least one, and preferably two, non-coplanar, parallel jaw surfaces.

As shown in FIG. 11, defined between the jaw surfaces of jaws 32a is a first wrenching span 50a, respectively defined by the first and second planar jaw surfaces that are substantially parallel to each other. The surfaces are preferably spaced apart a distance slightly greater than the minimum dimension of the mechanical device that the wrenching head is intended to accommodate, preferably 0.566 inches (14.38 mm). Similarly, defined between the second set of jaw surfaces is a second wrenching span 50b of 0.616 inches (20.73 mm), and between the third set of jaw surfaces is a third wrenching span 50c of 0.943 inches (23.95 mm).

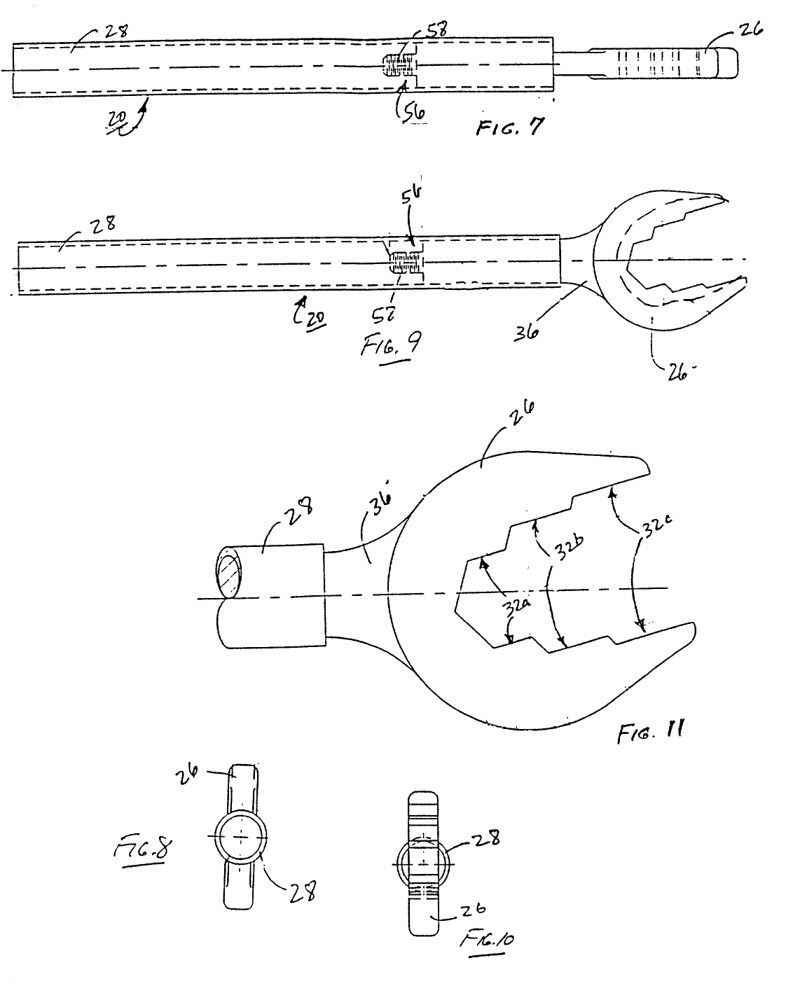

As shown in FIGS. 1-6, member 22 also includes a wrenching head 70. The wrenching head is of a design characterized as a split-box wrench. The split-box wrench head 70 comprises a multi-point box head 72 for engaging a mechanical device having a minimum diameter of a size indicated by arrow 74 (FIG. 6), where the minimum diameter is suitable for wrenching a device with an approximately ⅝ inch diameter. Accordingly, the spacing between opposing wrench surfaces is preferably 0.629 inches (15.98 mm). The split-box wrench head also has a split or aperture therein, the size of which is indicated by reference arrow 16 and is sufficient to allow wrench head 70 to pass around the outer perimeter of a pipe having an outside diameter smaller than 0.450 inches. The split-box wrench is preferably of a well-known 12-point design, suitable for engaging and wrenching hexagonal fittings, whereas the aperture is intended to accommodate the wrench head being used to tighten or loosen a compression nut.

Referring to FIGS. 1. 4, 7 and 9, there are illustrated orthogonal views of the first member 20 that is preferably engaged within the second member 22. The handle end 28 of member 22 and the shaft 78 of member 20 include mating fasteners 56 suitable for temporarily interconnecting the first and second members. The preferred mating fasteners 56 include a threaded member 58 extending from the first wrenching head along the longitudinal axis of the hollow handle of the first member and within the hollow handle.

In a preferred embodiment, the threaded member is less than 0.5 inches (12.5 mm) in length, tapered on the end thereof, and is threaded with a common ¼-20 UNC thread. The second element of mating fasteners 56 is a tapped hole 60 at the handle end of member 24, opposite the wrenching head. The hole extends longitudinally along the axis of the handle to a depth at least as great as the length of threaded member 58. Insertion of the handle of member 22 into the hollow handle of member 20, and the rotation of the first member in a clockwise direction relative to the second member causes the engagement of the threaded member 58 with the tapped hole 60 so as to temporarily connect said first and second members.

It will be appreciated by those skilled in the art of toolmaking that alternative mechanisms for the mating fasteners exist as well as variations thereof. One such alternative (not shown) is to magnetize the contact regions of the wrench members 20 and 22, or insert permanent magnetic components therein, near the mating fasteners 56. By magnetizing the regions or using permanent magnets with opposite polarity, it is possible to cause the two members to be magnetically attracted to one another when the handle of member 22 is inserted into the hollow handle of member 20. Yet further alternatives for the mating fasteners 56 would be a ball and detent mechanism and a spring-loaded button mechanism as described, for example, in co-pending application 09/523,031, previously incorporated by reference.

Referring now to FIG. 4, second member 22 has a further unique feature at the end of the handle opposite the wrench head. In particular, a lug or positioning member, generally indicated by reference numeral 90, is incorporated into the end of the handle. The positioning member includes a shoulder 92 and a reduced diameter section 94. Positioning member 90 is purposely designed to fit within the inside diameter of a ⅜ inch compression fitting. Positioning member 90 extends in a longitudinal direction a distance slightly longer than ¼ inch from the wrench handle. In a preferred embodiment, the outer edge of positioning member 90, and the edge of the handle at shoulder 92 are radiused or broken so as to make it easier to insert the postioning member into the plumbing fitting, and to make it easier to re-insert the positioning member end of handle 78 into the hollow handle of member 20. It will be appreciated that the diameter of the positioning member is preferably designed in accordance with the inner diameter of the riser opening on the fitting.

As further depicted in FIG. 4, the positioning member 90 is held at the extreme end of handle 78 by a spring 80 that pushes the positioning member outward until the shoulder 92 meets a curved outer edge of the handle shaft 78. Moreover, positioning member 90 is slidably inserted within the shaft 78, so that when a force is applied to the protruding end of the positioning member, the positioning member will completely retract within shaft 78. In this manner, the shaft 78, having an outer diameter of approximately 0.5 inches will fit within the inside diameter of a ⅝ inch compression fitting on a stop. Hence, the retractable positioning member 90, at the end of handle shaft 78 (when the positioning member is retracted), may be used to position two differently sized compression fittings (⅜ and ⅝ inch fittings).

As depicted in FIGS. 1 and 4, the retractable positioning member is retained within the handle, and the internal movement of the positioning member is limited by a dimple 96 or similar mechanism. The dimple prevents rotation of the positioning member within the shaft 78 so that the retractable lug positioning member 96 is unable to rotate as it is inserted within the handle 28 of member 20 and is rotated relative to member 20 so as to thread onto threaded member 58 of mating fastener 56.

In recapitulation, the present invention is an apparatus that may be employed in the installation of multiple sizes of compression valves or stops and their associated compression couplings. To overcome difficulties with the installation of compression and angle-stop devices, the two-piece apparatus enables the installation of a compression stop plumbing fitting, or similar mechanical device, without the need for any additional tools. In particular the end of one piece of the apparatus, when separated, allows the installer to grip the fitting on an interior surface so as to aid in aligning and tightening the compression fitting without marring outer surfaces thereof. Moreover, various features of the present invention facilitate the installation of such fittings in otherwise inaccessible areas.

It is, therefore, apparent that there has been provided, in accordance with the present invention, a two-piece apparatus for the installation of compression-type plumbing fittings. While this invention has been described in conjunction with preferred embodiment thereof, it is evident that many alternatives, modifications. and variations will be apparent to those skilled in the art. Accordingly, it is intended to embrace all such alternatives, modifications and variations that fall within the spirit and broad scope of the appended claims.

What is claimed is:

1. A two-part wrench, comprising:
a first member including a first wrenching head and an elongated, partially hollow handle extending therefrom, said first wrenching head being suitable for holding a mechanical device of one of three diameters; and
a second member including a second wrenching head and an elongated handle extending therefrom, said second wrenching head being suitable for holding a mechanical device having a plurality of generally flat sides intersecting at a plurality of corners;
wherein the elongated handle of the second member is suitable for slidable insertion, along a longitudinal direction, within the hollow handle of the first member, and wherein the first and second members each include complimentary mating fasteners to allow the temporary connection of the first and second members when the elongated handle of the second member is inserted within the hollow handle of the first member.

2. A two-part wrench, comprising:
a first member including a three-jawed open-end wrenching head and an elongated, hollow handle extending therefrom; and
a second member including a split-box wrenching head and an elongated handle extending therefrom,
wherein the elongated handle of the second member is suitable for slidable insertion, along a longitudinal direction, within the hollow handle of the first member, and wherein the first and second members each include complimentary mating fasteners to allow the temporary connection of the first and second members when the elongated handle of the second member is inserted within the hollow handle of the first member.

3. A wrench, comprising:
a wrenching head suitable for holding a mechanical device having a plurality of generally flat, parallel sides;
an elongated handle attached to and extending from said wrenching head; and
a retractable positioning member, said retractable positioning member extending longitudinally from an end of the elongated handle opposite the wrenching head, said retractable positioning member being of a first predetermined cross-section and of a first outer diameter suitable to engaging an inner surface of a mechanical device having the first predetermined cross-section, and the elongated handle being of a second outer cross-section suitable to engaging an inner surface of a second mechanical device having the second predetermined cross-section.
